(19) United States
(12) Patent Application Publication
(10) Pub. No.: US 2011/0116032 A1
(43) Pub. Date: May 19, 2011

(54) Eyeglasses with interchangeable inserts

(76) Inventors: Guy Brousseau, St-Jean sur Richelieu (CA); Louis-Martin Beausejour, St-Jean sur Richelieu (CA)

(21) Appl. No.: 12/929,399

(22) Filed: Jan. 21, 2011

Related U.S. Application Data
(63) Continuation-in-part of application No. 12/451,552, filed on Nov. 18, 2009, now Pat. No. 7,874,668.

(51) Int. Cl. G02C 11/02

(52) U.S. Cl. 351/52

(57) ABSTRACT

An eyeglass frame usable for supporting a first lens and a second lens, the eyeglass frame comprising: a first rim and a second rim, the first and second rims being provided for supporting respectively the first and second lenses; a bridge attaching the first and second rims to each other; a nose pad mechanically coupled to the first rim; a decorative insert; a first side arm, the first side arm defining an insert attachment for removably attaching the decorative insert thereto; and a first side arm attachment mechanically coupled to the first rim and to the first side arm for allowing pivotal movement of the first side arm relative to the first rim between an extended position and a retracted position, the first side arm being substantially parallel to the first rim when in the retracted position and the first side arm being substantially perpendicular to the first rim when in the extended position. The insert is resiliently deformable when attached to the insert attachment so as to bias the first side arm toward the retracted position when the first side arm is in the extended position.

This application is a continuation-in-part of U.S. patent application Ser. No. 12/451,552 filed Nov. 18, 2009, now issued to patent, which is a national entry of PCT application PCT/CA2008/000961 filed May 20, 2008, which claims priority from U.S. provisional application Ser. No. 60/924,508 filed May 18, 2007.

### FIELD OF THE INVENTION

The present invention relates to eyeglasses. More specifically, the present invention is concerned with eyeglasses with interchangeable nose pads.

### BACKGROUND

There are many types of eyeglasses having interchangeable side arms. In some of these eyeglasses, the side arms can be changed so as to provide different aesthetic aspects such as, for example, changing the colour of the side arm. Typically, these side arms are exchanged by snapping them in and out of place as they are removably attached to an attachment either extending from a lens of the eyeglasses, in the case of rimless eyeglasses, or from the frame of the eyeglasses, in the case of rimmed eyeglasses. A disadvantage of this type of side arms is that there is a need to change a relatively large component, the whole side arm, to change the appearance of the eyeglasses. Therefore, these side arms, which must be stored separately from the eyeglasses, are relatively cumbersome to carry efficiently by an intended user.

Furthermore, after a few tens or hundreds of side arm exchanges, the side arms and the part of the eyeglasses to which they attach can wear out and, therefore, provide for a relatively non-secure attachment of the side arms to the eyeglasses. This may lead to the side arms being relatively easily detached from the rest of the eyeglasses during normal use, which may eventually lead to the eyeglasses falling on the ground and getting damaged.

Furthermore, there are many eyeglasses including replaceable nose pads. However, these systems typically use nose pads having different dimensions so that the nose pads may be adjusted to the facial features of an intended user of the eyeglasses. This necessitates stores to carry many different sizes of nose pads so that each pair of eyeglasses may be fitted to an intended user. Also, such nose pads either typically include a metallic piece which may be deformed to finely adjust the nose pads to the face of the intended user, or are made out of a polymer which is relatively difficult to deform. In this latter case, it is relatively difficult to perfectly fit the eyeglasses to the intended user. Also, existing detachable nose pads are typically either firmly attachable to the remainder of the eyeglass frame, in which case they are relatively difficult to remove, or relatively loosely attached to the eyeglass frame, in which case they risk being accidentally removed from the eyeglass frame.

Against this background, there exist a need for a new and improved eyeglasses that avoids the aforementioned disadvantages.

### SUMMARY OF THE INVENTION

In a broad aspect, the invention provides an eyeglass frame, the eyeglass frame being usable for supporting a first lens and a second lens, the eyeglass frame comprising: a first rim and a second rim, the first and second rims being provided for supporting respectively the first and second lenses; a bridge attaching the first and second rims to each other; and a nose pad removably attachable to the first rim; the first rim defining a nose pad attachment for removably attaching the nose pad thereto, the nose pad attachment being deformable between a locked configuration in which the nose pad is fixedly attached to the nose pad attachment and an unlocked configuration in which the nose pad is movable relative to the nose pad attachment for selectively attaching the nose pad to the nose pad attachment and detaching the nose pad from the nose pad attachment; the first rim being deformable between a lens supporting configuration in which the first rim is able to support the first lens and a deformed configuration, the deformed configuration being achievable when the first rim is deprived of the first lens; wherein when the first rim is in the lens supporting configuration, the nose pad attachment is in the locked configuration and when the first rim is in the deformed configuration, the nose pad attachment is in the unlocked configuration.

The proposed eyeglass frame facilitates attachment and detachment of the nose pad to and from the first rim while ensuring that in use, accidental detachment of the nose pad is unlikely.

In some embodiments of the invention, a decorative insert is provided and is removably insertable into a side arm channel formed in a side arm of the eyeglass frame. In these embodiments, changing the decorative insert for another decorative insert having a different aesthetic appearance allows changing the appearance of the eyeglasses.

Typically, the decorative insert is relatively easily insertable into the side arm channel while being relatively solidly held into the side arm channel so as to reduce the likelihood of accidental detachment of the side arm channel. Furthermore, the insert being relatively small, it is relatively easily carried by intended users of the eyeglass frame.

Advantageously, the proposed eyeglass frame is relatively easily manufactured using known methods and materials.

In another broad aspect, the invention provides an eyeglass frame usable for supporting a first lens and a second lens, the eyeglass frame comprising: a first rim and a second rim, the first and second rims being provided for supporting respectively the first and second lenses; a bridge attaching the first and second rims to each other; a nose pad mechanically coupled to the first rim; a decorative insert; a first side arm, the first side arm defining an insert attachment for removably attaching the decorative insert thereto; and a first side arm attachment mechanically coupled to the first rim and to the first side arm for allowing pivotal movement of the first side arm relative to the first rim between an extended position and a retracted position, the first side arm being substantially parallel to the first rim when in the retracted position and the first side arm being substantially perpendicular to the first rim when in the extended position. The insert is resiliently deformable when attached to the insert attachment so as to bias the first side arm toward the retracted position when the first side arm is in the extended position.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

FIG. 1, in a perspective view, illustrates an eyeglass frame in accordance with an embodiment of the invention, the eyeglass frame being usable for supporting a first and a second lens, the first and second lenses being shown in phantom lines;

FIG. 2, in an exploded view, illustrates the eyeglass frame of FIG. 1;

FIG. 3a, in a partial side cross-sectional view, illustrates the eyeglass frame of FIGS. 1 and 2, the eyeglass frame including a rim and a nose pad, the eyeglass frame being shown with the nose pad detached from the rim;

FIG. 3b, in a partial side cross-sectional view, illustrates the eyeglass frame of FIGS. 1 to 3a with the nose pad shown attached to the rim;

FIG. 4a, in a bottom cross-sectional view, illustrates the eyeglass frame of FIGS. 1 to 3b, the eyeglass frame being shown with the nose pad detached from the rim;

FIG. 4b, in a bottom cross-sectional view, illustrates the eyeglass frame shown in FIGS. 1 to 4a with the nose pad in the process of being attached to the rim;

FIG. 4c, in a bottom cross-sectional view, illustrates the eyeglass frame shown in FIGS. 1 to 4b, the eyeglass frame being shown with the nose pad attached to the rim;

FIG. 5a, in a partial back elevation view, illustrates the eyeglass frame shown in FIGS. 1 to 4c with the nose pad detached from the rim and the eyeglass frame in a lens supporting configuration;

FIG. 5b, in a partial back elevation view, illustrates the eyeglass frame shown in FIGS. 1 to 5a with the nose pad detached from the rim and the eyeglass frame in a deformed configuration;

FIG. 5c, in a partial back elevation view, illustrates the eyeglass frame shown in FIGS. 1 to 5b with the nose pad attached to the rim and the eyeglass frame in the lens supporting configuration;

FIG. 6a, in a partial top elevation view, illustrates the nose pad of the eyeglass frame shown in FIGS. 1 to 5c, the nose pad being shown in two different configurations;

FIG. 6b, in a partial side cross-sectional view, illustrates the nose pad of the eyeglass frame shown in FIGS. 1 to 6a, the nose pad being shown in two different configurations;

FIG. 6c, in a partial rear elevation view, illustrates the nose pad of the eyeglass frame shown in FIGS. 1 to 6b, the nose pad being shown in two different configurations;

FIG. 7a, in a partial bottom cross-sectional view, illustrates the eyeglass frame shown in FIGS. 1 to 6c, the eyeglass frame being shown with a side arm thereof in an extended position and an insert inserted into a side arm channel defined by the side arm;

FIG. 7b, in a partial bottom cross-sectional view, illustrates the eyeglass frame shown in FIGS. 1 to 7a, the eyeglass frame being shown with a side arm thereof in a retracted position and the insert inserted into the side arm channel;

FIG. 7a, in a partial bottom cross-sectional view, illustrates the eyeglass frame shown in FIGS. 1 to 7b, the eyeglass frame being shown with a side arm thereof in an extended position and the insert partially removed from the side arm channel;

FIG. 8a, in a partial side elevation view, illustrates the side arm channel with the decorative insert partially inserted into the side arm channel;

FIG. 8b, in a partial side elevation view, illustrates the side arm channel with the decorative insert completely inserted into the side arm channel;

FIG. 9, in a front elevation view, illustrates an eyeglass frame in accordance with an alternative embodiment of the present invention;

FIG. 10, in a top cross-sectional view taken along the line X-X of FIG. 9, illustrates the eyeglass frame shown in FIG. 9;

FIG. 11, in a perspective, illustrates the eyeglass frame shown in FIGS. 9 and 10;

FIG. 12, in a partially exploded top cross-sectional view taken along the line X-X of FIG. 9, illustrates the eyeglass frame shown in FIGS. 9 to 11;

FIG. 13, in a partial top cross-sectional view taken along the line X-X of FIG. 9, illustrates the eyeglass frame shown in FIGS. 9 to 12, an insert part of the eyeglass frame being shown in an undeformed configuration; and

FIG. 14, in a partial top cross-sectional view taken along the line X-X of FIG. 9, illustrates the eyeglass frame shown in FIGS. 9 to 13, the insert being shown in a deformed configuration.

### DETAILED DESCRIPTION

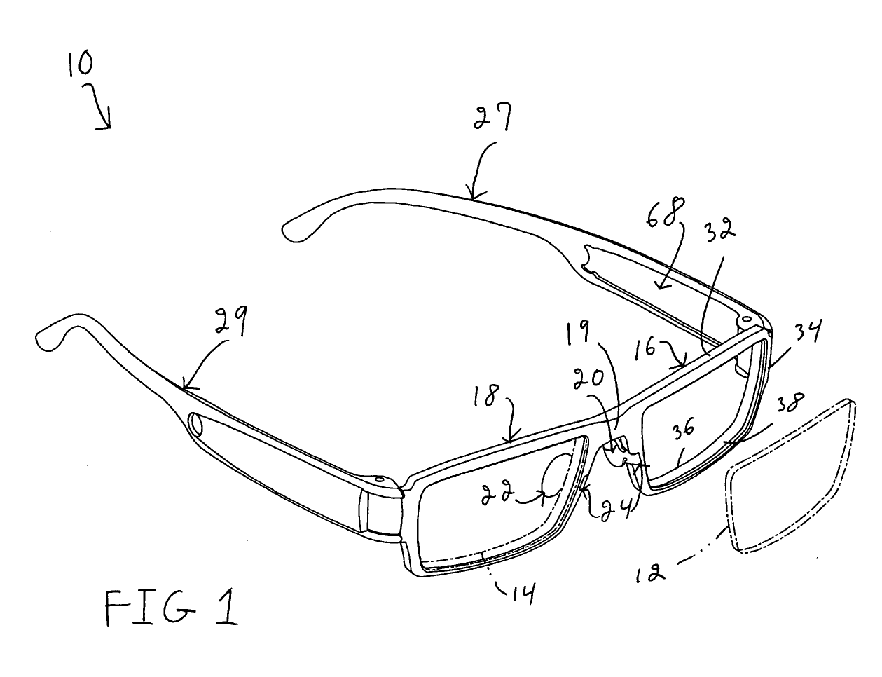

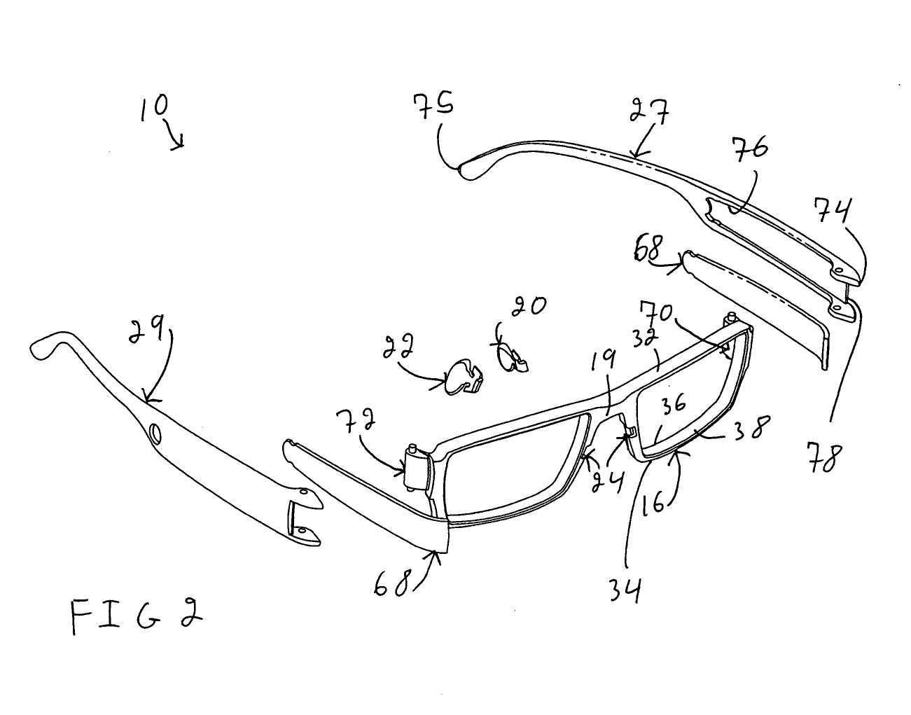

Referring to FIGS. 1 and 2, there is shown an eyeglass frame 10 in accordance with an embodiment of the present invention. The eyeglass frame 10 is usable for supporting a first lens 12 and a second lens 14, both shown in phantom lines and only in FIG. 1. The eyeglass frame 10 includes a first rim 16 and a second rim 18. The first and second rims 16 and 18 are provided for supporting respectively the first and second lenses 12 and 14, as shown in FIG. 1. A bridge 19 attaches the first and second rims 16 and 18 to each other. A nose pad 20 is removably attachable to the first rim 16. Also, typically, another nose pad 22 is also removably attachable to the second rim 18. The two nose pads 20 and 22 are substantially similar to each other and the first and second rims 16 and 18 are also substantially similar to each other. Accordingly, hereinbelow, only the first nose pad 20 and the first rim 16 are described in details.

Typically, the eyeglass frame 10 also includes a first side arm 27 and a second side arm 29 both pivotably attached to the remainder of the eyeglass frame 10 in a conventional manner. The two side arms 27 and 29 are substantially similar to each other and only the side arm 27 is described in details hereinbelow.

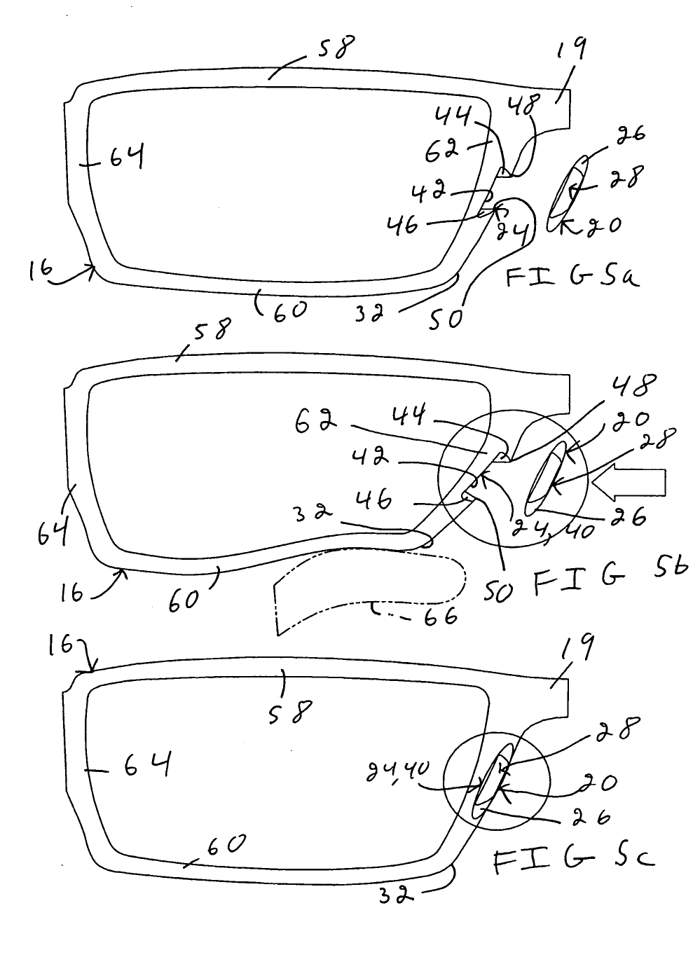

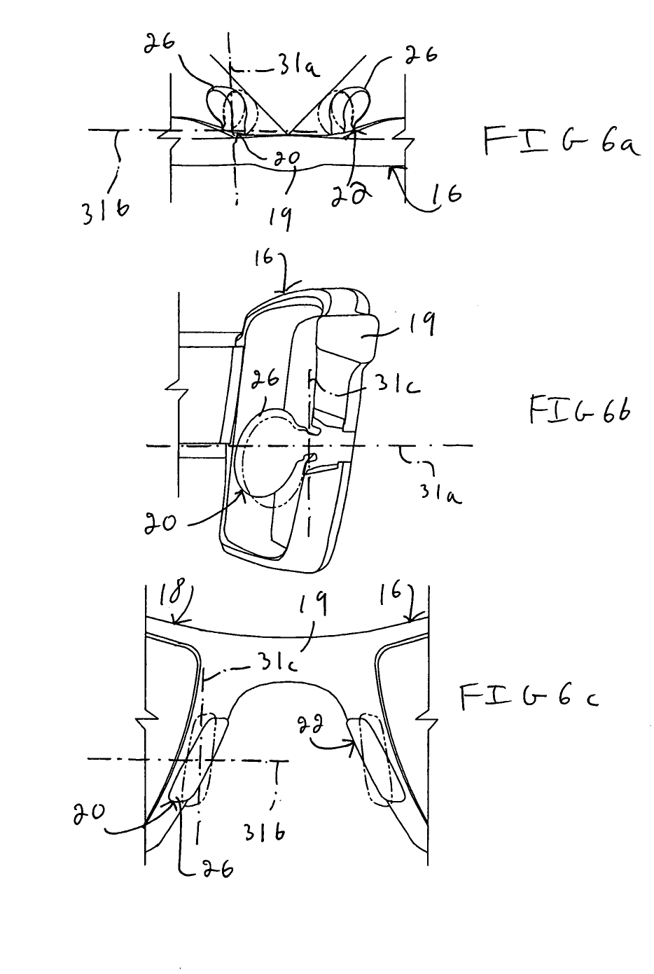

The first rim 16 defines a nose pad attachment 24 for removably attaching the nose pad 20 thereto. The nose pad attachment 24 is deformable to a locked configuration, as shown for example in FIGS. 5a and 5c, in which the nose pad 20 is fixedly attachable to the nose pad attachment 24. The nose pad attachment 24 is also deformable to an unlocked configuration, as shown for example in FIG. 5b, in which the nose pad 20 is movable relative to the nose pad attachment 24 for selectively attaching the nose pad 20 to the nose pad attachment 24 and detaching the nose pad 20 from the nose pad attachment 24.

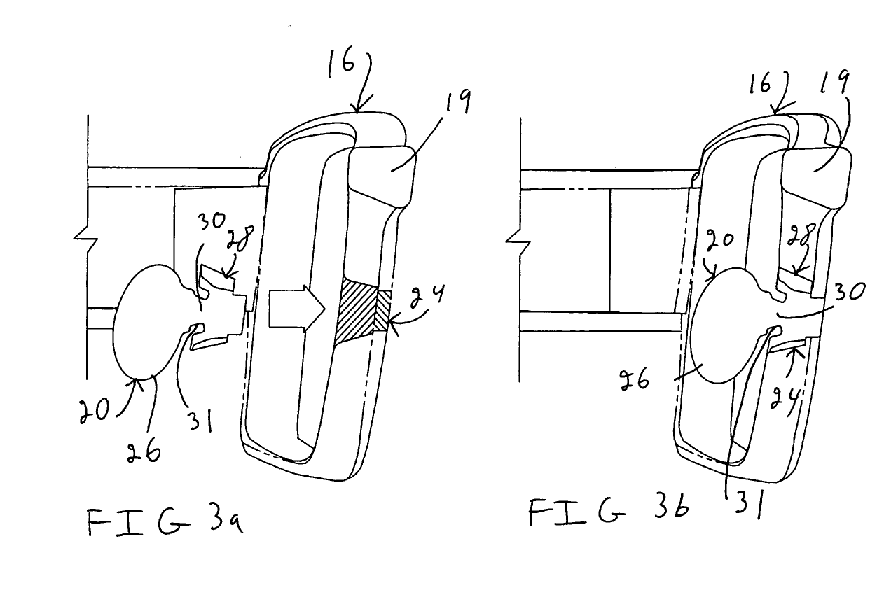

The first rim 16 is deformable between a lens supporting configuration, as shown for example in FIG. 5a, in which the first rim 16 is able to support the first lens 12, and a deformed configuration, as shown for example in FIG. 5b, the deformed configuration being achievable when the first rim 16 is deprived of the first lens 12. When the first rim 16 is in the lens supporting configuration, the nose pad attachment 24 is in the locked configuration and when the first rim 16 is in the deformed configuration, the nose pad attachment 24 is in the unlocked configuration. As seen for example in FIGS. 3a and 3b, the nose pad 20 defines a pad portion 26 and an attachment portion 28. The attachment portion 28 is removably attachable to the nose pad attachment 24. The pad portion 26 is usable for supporting the eyeglass frame 10 onto the nose of an intended user (both not shown in the drawings). The pad portion 26 is conventional and will therefore not be described in further details.

In some embodiments of the invention, the nose pad 20 includes a deformable portion 30 extending between the pad portion 26 and the attachment portion 28. The deformable portion 30 is typically deformable about three substantially orthogonal axes for allowing the pad portion 26 to move relative to the attachment portion 28 in every direction. This capability to accommodate relative movements between the pad portion 26 and the attachment portion 28 allows for adjustments of the nose pad 20 to the morphology of the intended user. In some embodiments of the invention, deformable portion 30 includes a nose pad neck 31 located between the attachment and pad portions 28 and 26. The nose pad neck 31 is a section of the nose pad 20 that is substantially thinned out relative to the pad portion 26 and the attachment portion 28.

The deformable portion 30 is typically dimensioned and made out of a material such that the deformable portion 30 is deformable over a relatively large number of deformations cycles and over a relatively large range without experiencing fatigue failure. For example, in some embodiments of the invention, the deformable portion 30 has dimensions of from about 0.5 to about 3 mm in directions substantially perpendicular to a direction leading from pad portion 26 toward the attachment portion 28 and is made out of Grivory EMS Grilamid, TR-90 or a similar material.

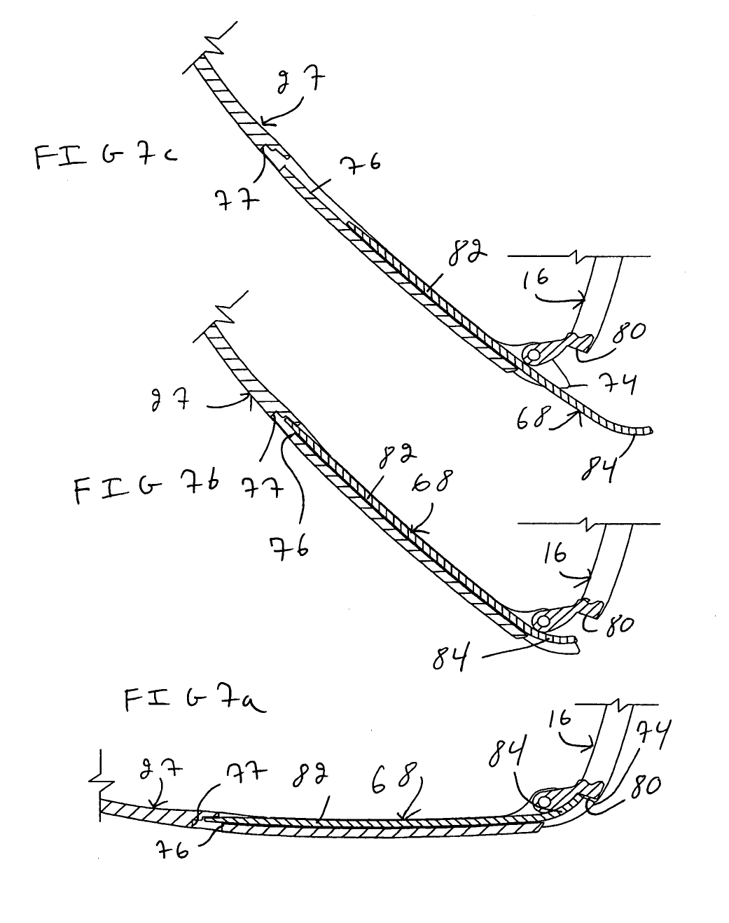

As seen in FIGS. 6a, 6b and 6c, the deformable portion 30 allows for moving the pad portion 26 relatively to the attachment portion 28 and, therefore, to the first rim 12, about three orthogonal axes 31a, 31b and 31c. In FIGS. 6a, 6b and 6c, the pad portion 26 is shown in 2 different positions, one of which is in full lines, and the other one of which is in phantom lines.

Referring to FIG. 2, the first rim 16 defines a first rim peripheral surface 32. In addition, the first rim 16 defines substantially opposed first rim front and back surfaces 34 and 36. The first rim peripheral surface 32 extends between the first rim front and back surfaces 34 and 36. The first rim front surface 34 is further away from the face of the intended user (not shown in the drawings) than the first rim back surface 36 when the eyeglass frame 10 is worn by the intended user in an operative configuration. In addition, the first rim 16 defines a rim inner surface 38 substantially opposed to the first rim peripheral surface 32 and extending between the rim front and back surfaces 34 and 36. Typically, the rim inner surface 38 is configured and sized for fixedly receiving and engaging the first lens 12 in a conventional manner.

Referring to FIG. 5a, the nose pad attachment 24 includes a groove 40 extending substantially radially inwardly into the first rim peripheral surface 32. Typically, the groove 40 is located substantially adjacent the bridge 19 but, in alternative embodiments of the invention, the groove 40 is positioned at any other suitable location.

As better seen in FIGS. 5a and 5b, the groove 40 is delimited by a groove end surface 42 and a pair of substantially circumferentially spaced apart lateral surfaces 44 and 46, each extending substantially radially outwardly from the groove end surface 42. The groove lateral surfaces 42 and 44 taper toward each other in a direction leading substantially away from the groove end surface 42 when the nose pad attachment 24 is in the locked configuration.

In some embodiments of the invention, the groove lateral surfaces 44 and 46 each define a respective groove lateral surface distal end 48 and 50 substantially adjacent to the first rim peripheral surface 32. The groove lateral surface distal ends 48 and 50 are spaced apart by a greater distance in the unlocked configuration than in the locked configuration. In some embodiments of the invention, the groove lateral surfaces 44 and 46 are substantially parallel to each other when the nose pad attachment 24 is in the unlocked configuration, as seen in FIG. 5b.

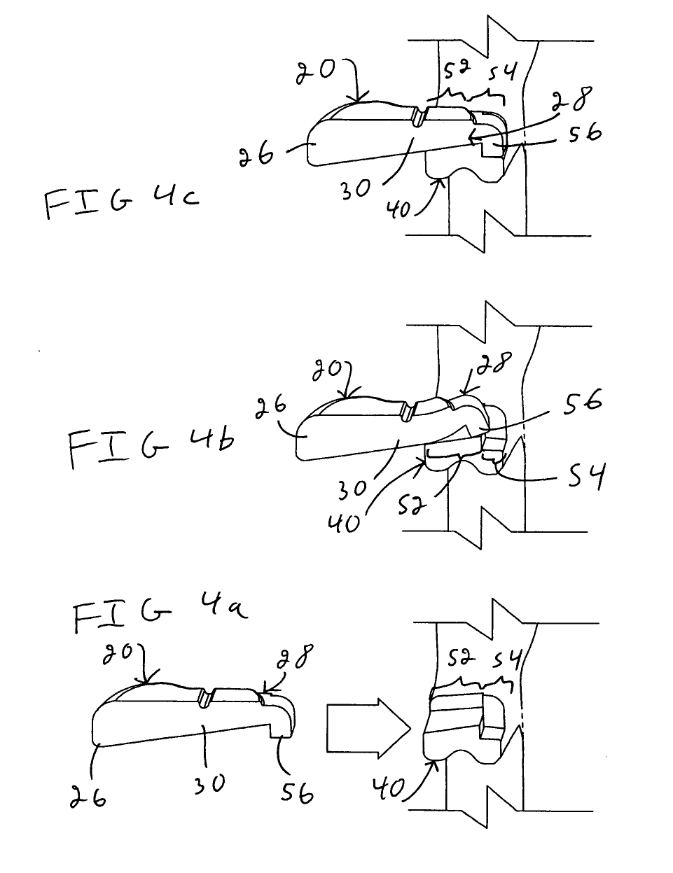

In some embodiments, as seen for example in FIG. 4a, the groove 40 defines a groove first section 52 and an axially extending groove second section 54. The groove second section 54 extends radially inwardly into the first rim peripheral surface 32 over a greater extent than the groove first section 52. As seen in FIG. 3a. in some embodiments of the invention, the groove first and second lateral surfaces 44 and 46 are tapered towards each in a direction leading from the groove first section 52 towards the groove second section 54. Typically, to improve the aesthetics of the eyeglass frame 10, the groove first section 52 is located substantially adjacent the first rim back surface 36.

Typically, a section of the attachment portion 28 that is received inside the groove 40 when the nose pad 20 is attached to the first rim 16 is shaped substantially similarly to the groove 40 so as to be maintained thereinto by the groove end and lateral surfaces 42, 44 and 46 (seen in FIGS. 5a, 5b and 5c). Accordingly, as seen for example in FIG. 4a. the attachment portion 28 is provided with a distal tongue 56 dimensioned for engaging the groove 40 into the groove second section 54.

In some embodiments of the invention, the attachment portion 28 is substantially resiliently deformable for allowing insertion of the attachment portion 28 substantially axially into the groove 40 without deforming necessarily the groove 40 so that the nose pad attachment 24 is in the unlocked configuration. However, because of the tongue 56, the reverse movement, in other words, detachment of the nose pad 20 from the remainder of the rim 16, is unlikely to happen without outside intervention. In these embodiments, this provides an alternative manner of attaching the nose pad 20 to the first rim 16 that is achievable even if the first lens 12 is received by the first rim 16.

With reference to FIGS. 5a to 5c, the first rim 16 defines substantially opposed first rim top and bottom segments 58 and 60 and substantially opposed rim lateral segments 62 and 64 each extending between the first rim top and bottom segments 58 and 60. The groove 40 is formed in one of the rim lateral segments, namely rim lateral segment 62. As seen in FIG. 5b, in the deformed configuration, the first rim top and bottom segments 58 and 60 are deformed towards each other.

In some embodiments of the invention, the nose pad 20 is substantially freely movable relative to the nose pad attachment 24 when the nose pad attachment 24 is in the unlocked configuration. For example, the nose pad 20 is substantially radially freely movable relative to the nose pad attachment 24 when the nose pad attachment 24 is in the unlocked configuration.

In use, with reference to FIGS. 5a to 5c, to insert the nose pad 20 in the groove 40, an intended user typically uses a finger 66, shown in FIG. 5b, to deform one of the first rim top and bottom segments 58 and 60, or to deform both the first rim top and bottom segments 58 and 60 towards each other. This creates a strain in the first rim peripheral surface 32, which pulls apart from each other the groove lateral surface distal ends 48 and 50. In turn, this movement allows for inserting relatively easily the attachment portion 28 inside the groove 40. After having released the rim 16, the nose pad attachment 24 recovers the locked configuration and the nose pad 20 is prevented from moving out of the groove 40 by the tapered configuration in two different directions of the groove lateral surfaces 44 and 46 and by the tongue 56, as seen for example in FIG. 4c.

In some embodiments of the invention, the eyeglass frame 10 includes a decorative insert 68 and the first side arm 27 defines an insert attachment for removably attaching the decorative insert 68 thereto. Typically, the second side arm 29 also defines an insert attachment for attaching a similar decorative insert 68 thereto.

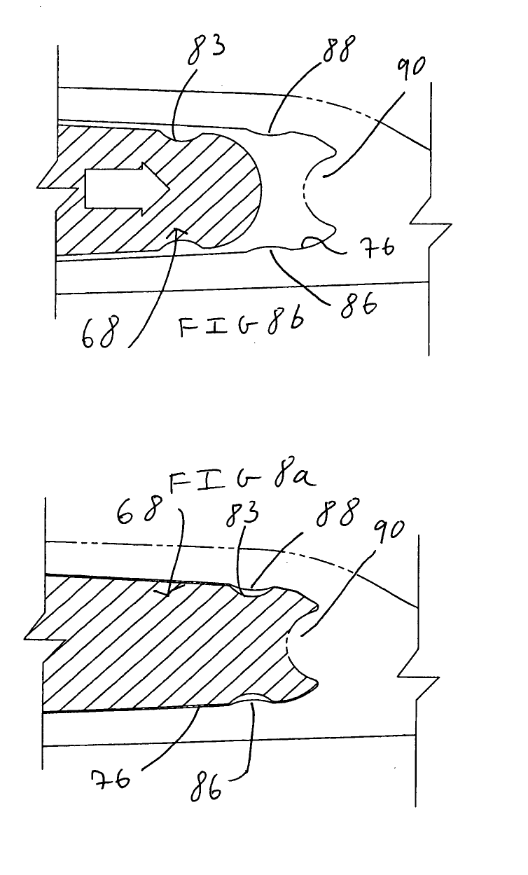

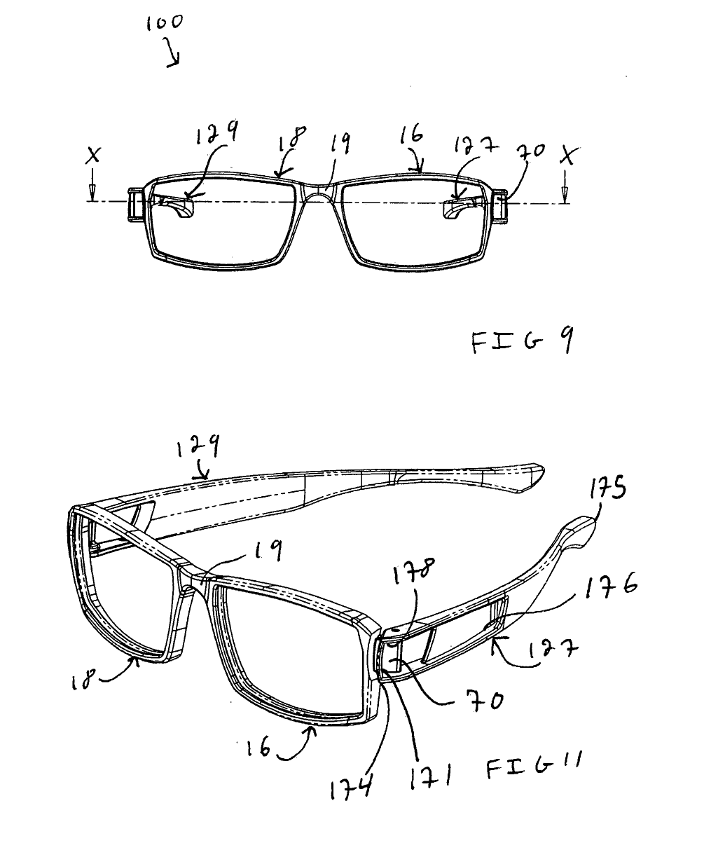

The eyeglass frame 10 also includes a first side arm attachment 70 and a second side arm attachment 72 respectively mechanically coupled to the first and second rims 16 and 18 and respectively to the first and second side arms 27 and 29 for allowing pivotal movement of the first and second side arms 27 and 29 relative to the first and second rims 16 and 18. Typically, the side arm attachments 70 and 72 extend substantially laterally outwardly from the rims 16 and 18 such that the side arms 27 and 29 are attached to locations located laterally outside of the lenses 12 and 14. The first and second side arms 27 and 29 are pivotable relative to the first and second rims 16 and 18 between a retracted position, shown for example in FIG. 7c for the first side arm 27, and an extended position, shown for example in FIG. 7a for the first side arm 27.

The first side arm 27 is substantially elongated and defines a first arm first end 74 and a substantially opposed first arm second end 75, the first arm first end 74 being substantially adjacent to the first side arm attachment 70. The insert attachment includes a first arm channel 76 defined in the first side arm 27 and extending substantially longitudinally thereinto, the first arm channel 76 defining a channel end opening 78 substantially adjacent the first arm first end 74. Typically, the first arm channel 76 has a substantially C-shaped lateral cross-sectional configuration at least along a portion thereof and opens either toward the first rim 16 or away from the first rim 16. The decorative insert 68 is slidably receivable inside the first arm channel 76 through the channel end opening 78. In addition, in some embodiments of the invention, the first side arm 27 defines a channel distal aperture 77 substantially opposed to the channel end opening 78. In some embodiments of the invention, the first side arm is substantially transparent or translucent substantially in register with the first arm channel 76.

The first side arm attachment 70 defines a side arm attachment abutment surface 80. When the decorative insert 68 is inserted in the first arm channel 76, the decorative insert 68 is substantially prevented from sliding out of the first arm channel 76 by the side arm attachment abutment surface 80 when the first side arm 27 is in the extended position. The decorative insert 68 is slidable out of the first arm channel 76 through the channel end opening 78 when the first side arm 27 is in the in the retracted position. For example, in some embodiments of the invention, the decorative insert 68 abuts against the side arm attachment abutment surface 80 when the decorative insert 68 is inserted in the first arm channel 76 and the first side arm 27 is in the extended position. In some embodiments of the invention, it has been found advantageous for facilitating retention of the decorative insert 68 in the first arm channel 76 to have a side arm attachment abutment surface 80 that is substantially planar and angled at an angle of from about 10 to about 85 degrees relative to the first arm channel 76 when the first side arm 27 is in the extended position.

The decorative insert 68 includes a channel insertable portion 82 receivable inside the first arm channel 76 and an end portion 84 positionable outside of the first arm channel 76 with the channel insertable portion 82 received in the first arm channel 76. The end portion 84 has typically a substantially arc segment shaped configuration and extends substantially toward the first rim 16 when the channel insertable portion 82 is inserted in the first arm channel 76 and the first side arm 27 is in the extended position. The shape of the end portion 84, in addition to securing the decorative insert 68 inside the first arm channel 76, facilitates the intentional removal of the decorative insert 68 from the first arm channel 76 by providing grip to the hand and fingers of the intended user.

In some embodiments of the invention, as seen in FIGS. 8a and 8b, the decorative insert 68 defines a neck portion 83 and the first side arm 27 defines pair of protrusions 86 and 88 extending substantially laterally into the first arm channel 76. The protrusions 86 and 88 engage the neck portion 83 when the decorative insert 68 is received inside the first arm channel 76. The protrusions 86 and 88 therefore help in retaining the decorative insert 68 in the first arm channel 76.

In some embodiments of the invention, the first side arm 27 defines a tongue 90 extending substantially longitudinally into the first arm channel 76 substantially opposed to the channel end opening 78. The tongue 90 frictionally engages the decorative insert 68 for frictionally retaining the decorative insert 68 in the first arm channel 76. The channel distal aperture 77 is located substantially in register with the tongue 90 and receives the distal end of the decorative insert 68.

In use, to manipulate the decorative inserts 68, the side arms 27 and 29 are moved to their respective retracted configuration so that a respective decorative insert 68 can be slidably inserted thereinto. The decorative inserts 68 are typically relatively easily removable from the side arm channel 76 to facilitate their exchange with decorative inserts 68 providing a different decoration.

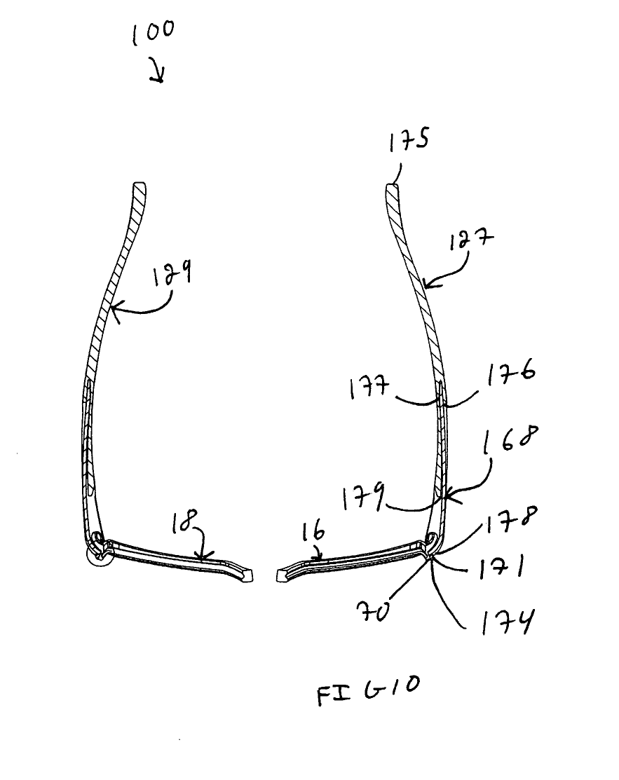

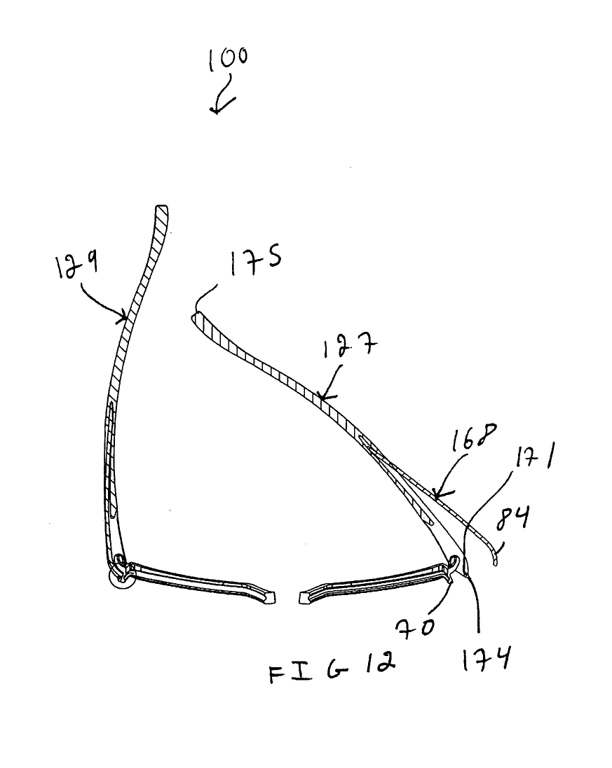

FIGS. 9 to 14 illustrate an alternative eyeglass frame 100 in which reference numerals identical to reference numerals used to describe the eyeglass frame 10 describe similar structures. The eyeglass frame 100 is similar in many aspects to the eyeglass frame 10 and only differences between the eyeglass frames 10 and 100 are described herein.

The eyeglass frame 100 is shown in the drawings without a nose pad. In some embodiments of the invention, a nose pad similar to the nose pad 20 is included in the eyeglass frame 100. In alternative embodiments of the invention, any other type of nose pad, or no nose pad, is included in the eyeglass frame 100.

One of the differences between the eyeglass frame 100 and the eyeglass frame 10 resides in that the eyeglass frame 100 includes a decorative insert 168, seen in FIGS. 12 to 14, that is resiliently deformable when attached to the insert attachment of the first and second side arms 127 and 129 of the eyeglass frame 100 so as to bias the first and second side arms 127 and 129 toward the retracted position when the first and second side arms 127 and 129 are in the extended position.

More specifically, referring to FIG. 10, the eyeglass frame 100 includes alternative first and second side arms 127 and 129. The second side arm 129 is substantially similar to the first side arm 127 and is therefore not described in details herein. The first side arm 127 is substantially elongated and defines a first arm first end 174 and a substantially opposed first arm second end 175, the first arm first end 174 being substantially adjacent to the first side arm attachment 70. The insert attachment of the first side arm 127 includes a first arm channel 176 defined in the first side arm 127 and extending substantially longitudinally thereinto, the first arm channel 176 defining a channel end opening 178 substantially adjacent the first arm first end 174. Typically, the first arm channel 176 has a substantially C-shaped transversal cross-sectional configuration at least along a portion thereof and opens laterally away from the first rim 16. The decorative insert 168 is slidably receivable inside the first arm channel 76 through the channel end opening 78. In addition, in some embodiments of the invention, the first side arm 127 defines a channel proximal aperture 179 that opens substantially laterally inwardly with respect to the first rim 16. The first side arm 127 also defines a channel pocket 177 substantially opposed to the channel end opening 178 for receiving the distal end of the decorative insert 168 thereinto.

The first side arm 127 includes a proximal end wall 171 extending substantially adjacent the channel end opening 178. The proximal end wall 171 maintains the decorative insert 168 in the first arm channel 176 when the decorative insert 168 is attached to the first side arm 127. To that effect, the decorative insert 168 is inserted between the proximal end wall 171 and the channel pocket 177 when attached to the first side arm 127.

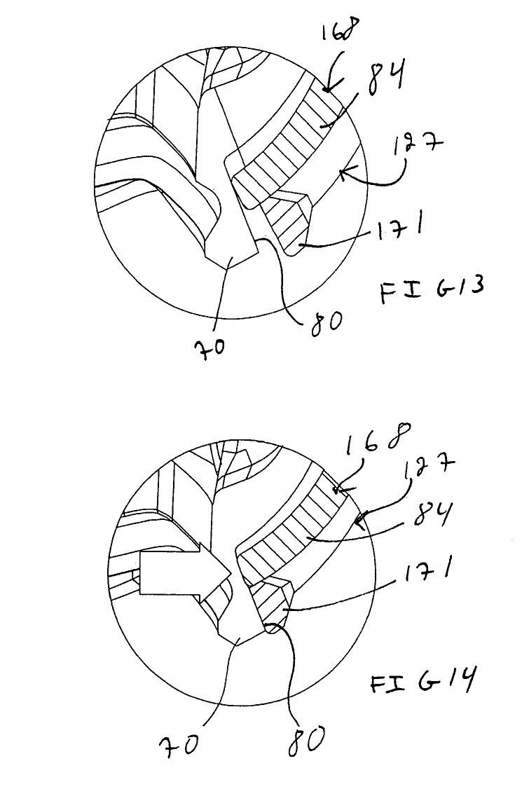

The decorative insert 168 is substantially similar in structure to the decorative insert 68. As seen in FIGS. 13 and 14, when the decorative insert 168 is attached to the first side arm 127 and the first side arm 127 is in the extended position, the end portion 84 of the decorative insert 168 abuts against the side arm attachment abutment surface 80 and against the proximal end wall 171. The dimensions of the decorative insert 168 are such that the end portion 84 protrudes laterally inwardly from the proximal end wall 171.

The decorative insert 168 is substantially resiliently deformable between an undeformed configuration, seen in FIG. 13, and a deformed configuration, seen in FIG. 14. In the deformed configuration, the first side arm 127 has been pivoted laterally outwardly over a distance such that the free end of the end portion 84 is retracted toward the proximal end wall 171 with respect to the undeformed configuration. This deformation causes a biasing force that is directed toward achieving the undeformed configuration. In turn, this causes a force on the first side arm 127, through contact with the side arm attachment abutment surface 80, that biases the first side arm 127 toward the retracted position. This force stabilizes the eyeglass frame 100 on the head of an intended user (not shown in the drawings).

Although the present invention has been described hereinabove by way of preferred embodiments thereof, it can be modified, without departing from the spirit and nature of the subject invention as defined in the appended claims.

What is claimed is:

1. An eyeglass frame, said eyeglass frame being usable for supporting a first lens and a second lens, said eyeglass frame comprising:
a first rim and a second rim, said first and second rims being provided for supporting respectively said first and second lenses;
a bridge attaching said first and second rims to each other; and
a nose pad mechanically coupled to said first rim;
a decorative insert;
a first side arm, said first side arm defining an insert attachment for removably attaching said decorative insert thereto;
a first side arm attachment mechanically coupled to said first rim and to said first side arm for allowing pivotal movement of said first side arm relative to said first rim between an extended position and a retracted position, said first side arm being substantially parallel to said first rim when in said retracted position and said first side arm being substantially perpendicular to said first rim when in said extended position;
wherein said insert is resiliently deformable when attached to said insert attachment so as to bias said first side arm toward said retracted position when said first side arm is in said extended position.
